(19) United States
(12) Patent Application Publication
(10) Pub. No.: US 2014/0330450 A1
(43) Pub. Date: Nov. 6, 2014

(54) MOBILE MONITORING DEVICE FOR VEHICLES

(71) Applicant: Alexandre Dos Santos, Montreal (CA)

(72) Inventor: Alexandre Dos Santos, Montreal (CA)

(21) Appl. No.: 13/887,237

(22) Filed: May 3, 2013

(51) Int. Cl. B60R 99/00

(52) U.S. Cl. CPC B60R 99/00
USPC 701/2; 701/49

(57) ABSTRACT

A mobile monitoring device for monitoring a vehicle comprising a mobile unit, a vehicle engaging element movably mounted to the mobile unit and comprising a monitoring device and a movement imparting assembly mounted to the mobile unit for imparting a movement to the mobile unit and to the vehicle engaging element. The movement imparting assembly provides for moving the mobile unit towards the vehicle and moving the vehicle engaging element onto the vehicle thereby providing for the monitoring device to be mounted to the vehicle.

### CROSS-REFERENCE TO RELATED APPLICATIONS

The present application claims priority on U.S. Provisional Application No. 61/642,157 filed on May 3, 2012 and incorporated herein in its entirety.

### TECHNICAL FIELD

The present disclosure relates to monitoring devices such as tracking and listening devices. More particularly the present disclosure relates to a mobile monitoring device for vehicles. More specifically, but still not exclusively, the present disclosure relates to a mobile tracking and/or listening device for vehicles.

### BACKGROUND

Vehicle tracking and listening devices used by military or law enforcement personnel and investigators are well known and commonly used. Tracking devices includes GPS units and listening devices include miniature microphones (commonly referred to as “bugs”) that are removably mounted to a vehicle, such as a car, a van, a truck, a watercraft and the like. These devices once mounted to their target vehicle track the whereabouts and trajectory of the vehicle in real time. Listening devices also allow for capturing various sounds including conversation between individuals within the vehicles or in the vicinity of the vehicles. As such, military or law enforcement personnel and investigators can collect intelligence on the tracked and audio monitored targets.

A drawback of current devices is that that they require an authorized individual to physically mount such a device on the targeted vehicle. The foregoing can compromise the confidentiality of an investigation as the authorized individual may be seen by the targeted subject or by another bystander.

### OBJECTS

It is an object of the present disclosure to provide a mobile monitoring device for vehicles.

It is an object of the present disclosure to provide a mobile tracking and/or listening device for vehicles.

It is an object of the present disclosure to provide a mobile tracking device for vehicles.

It is an object of the present disclosure to provide a mobile listening device for vehicles.

### SUMMARY

In accordance with an aspect of the disclosure there is provided a mobile monitoring device for monitoring a vehicle comprising: a mobile unit; a vehicle engaging element movably mounted to the mobile unit and comprising a monitoring device; and a movement imparting assembly mounted to the mobile unit for imparting a movement to the mobile unit and to the vehicle engaging element, wherein the controller provides for moving the mobile unit towards the vehicle and moving the vehicle engaging element onto the vehicle thereby providing for the monitoring device to be mounted to the vehicle.

In an embodiment, the mobile monitoring device further comprises controller in communication with the movement imparting assembly for control thereof. In an embodiment, the controller comprises a visual display for displaying the images captured by the camera. In an embodiment, the controller provides for remotely controlling the movement imparting assembly. In an embodiment, the controller is in communication with the monitoring device for receiving monitored information therefrom.

In an embodiment, the monitoring device comprises mounting elements for being mounted to the vehicle. In an embodiment, the mounting elements are selected from the group consisting of: magnets and clamps.

In an embodiment, the vehicle engaging element comprises a platform, the monitoring device being mounted to the platform. In an embodiment, the vehicle engaging element and the monitoring device form a single integrated piece. In an embodiment, the vehicle engaging element comprises connectors for connecting the monitoring device thereto. In an embodiment, the connectors are movable between a connecting position and a releasing position, the controller providing for selectively releasing the monitoring device when mounted to the vehicle. In an embodiment, the vehicle engaging element is moved onto the vehicle so as to be mounted thereto and wherein the movement imparting assembly provides for moving the mobile unit towards the vehicle engaging element mounted to the vehicle, thereby providing for mounting the mobile unit onto the vehicle. In an embodiment, the vehicle engaging element comprises a camera.

In an embodiment, the movement imparting assembly provides for moving the mobile unit away from the vehicle subsequently to having been moved onto the vehicle.

In an embodiment, the mobile unit is configured to be moved by the movement imparting assembly beneath the vehicle, the vehicle engaging element being configured to be lifted by the movement imparting assembly so as to engage an underneath portion of the vehicle. In an embodiment, the mobile unit comprises rollers in operative communication with the movement imparting assembly. In an embodiment, the mobile unit comprises at least one camera in communication with the controller.

In an embodiment, the monitoring device comprises a tracking device.

In an embodiment, the tracking device is selected form the group consisting of a GPS unit, a listening device and any combination thereof.

In accordance with an aspect of the disclosure, there is provided a monitoring system comprising: a plurality of the mobile monitoring devices; and a controller in communication with the monitoring device of each of the mobile monitoring devices for receiving monitoring information therefrom.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE FIGURES

In the appended drawings, where like reference numerals indicate like elements throughout and where:

FIG. 1 is a perspective view of a mobile monitoring device for vehicles in accordance with a non-limiting illustrative embodiment of the present disclosure;

FIG. 2 is a top plan view of the mobile monitoring device of FIG. 1;

FIG. 3 is a perspective view of the mobile monitoring device of FIG. 1 with the vehicle engaging element in the lifted position in accordance with a non-limiting illustrative embodiment of the present disclosure;

FIG. 4 is a bottom perspective view of the mobile monitoring device of FIG. 1;

FIG. 5 is perspective view of the mobile monitoring device of Figure in the process of engaging a vehicle;

FIGS. 6A, 6B and 6C are sequential side views of the mobile monitoring device of FIG. 1 engaging a vehicle for mounting a monitoring device thereto in accordance with a non-limiting illustrative embodiment of the present disclosure;

FIGS. 7A, 7B and 7C are sequential side views of a mobile monitoring device in accordance with another non-limiting illustrative embodiment of the present disclosure, engaging a vehicle for mounting a monitoring device thereto; and

FIGS. 8A, 8B and 8C are sequential side views of a mobile monitoring device in accordance with a further non-limiting illustrative embodiment of the present disclosure, engaging a vehicle for mounting a monitoring device thereto.

### DETAILED DESCRIPTION OF THE ILLUSTRATIVE EMBODIMENTS

In accordance with an embodiment, there is provided a mobile monitoring device for monitoring a vehicle comprising a mobile unit, a vehicle engaging element movably mounted to the mobile unit and comprising a monitoring device and a movement imparting assembly mounted to the mobile unit for imparting a movement to the mobile unit and to the vehicle engaging element. The movement imparting assembly provides for moving the mobile unit towards the vehicle and moving the vehicle engaging element onto the vehicle thereby providing for the monitoring device to be mounted to the vehicle.

In accordance with an embodiment, there is provided a mobile monitoring device for monitoring a vehicle comprising a mobile unit, a movement imparting assembly mounted to the mobile unit, a controller in communication with the movement imparting assembly and a monitoring device supported by the mobile unit. The mobile unit comprises mobility members and a vehicle engaging element. The controller provides for moving the mobile unit towards the vehicle and moving the vehicle engaging element onto the vehicle thereby providing for the monitoring device to be mounted to the vehicle. In an embodiment, the monitoring device can be a tracking device and/or a listening device. In an embodiment, the mobility members are rollers. In an embodiment, the controller is a remote controller. In an embodiment, the vehicle engaging element is a platform supporting the monitoring device. In an embodiment, the mobile unit is moved beneath a vehicle, the platform is lifted and the monitoring unit is mounted to the vehicle on an underneath portion thereof.

With reference to the Figures non-limiting examples of the disclosure will now be described.

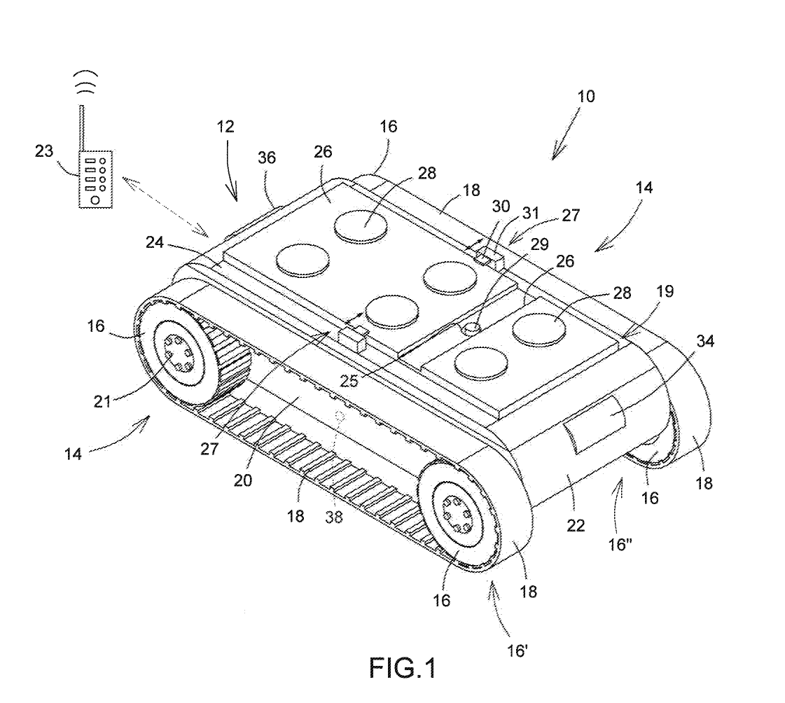

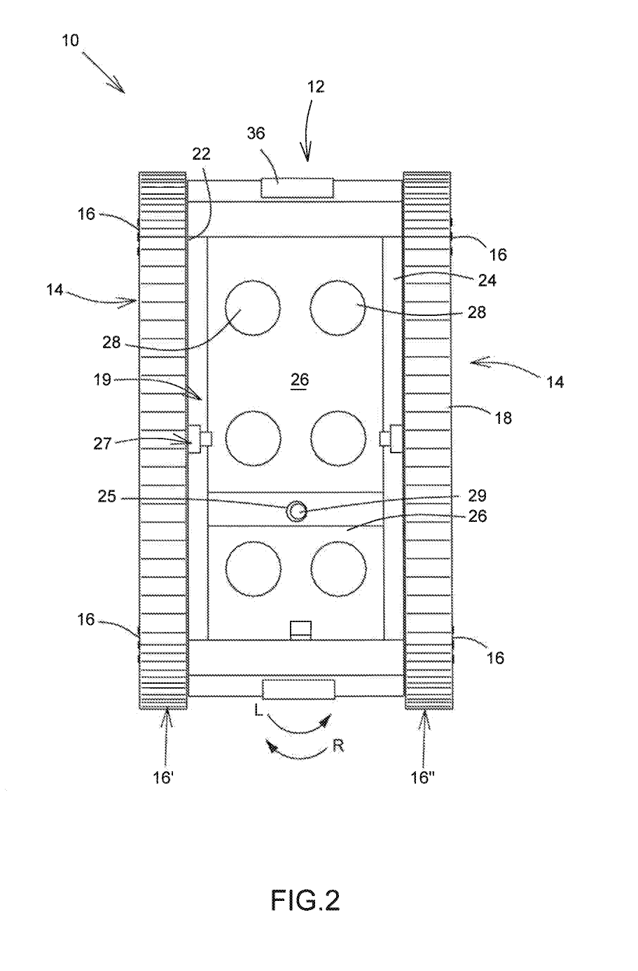

FIGS. 1 and 2 show a mobile monitoring device 10 for vehicles. The device 10 includes a mobile unit 12 having movement imparting members or mobility members 14. The movement imparting members 14 are in the form of rollers 16 with an endless track 18 mounted thereto. Each roller 16 is mounted to the chassis 20 of the mobile unit 12 and actuated by a shaft 21 connected to an actuator 22.

The actuator 22 is mounted to the chassis 20 and powers at least a pair of adjacent rollers 16, specifically 16′ and 16″, for imparting a movement to the mobile unit 12. As the skilled artisan will readily appreciate the actuator 22 is configured to provide the rollers 16 to turn in a clockwise fashion for forward movement and a counter clockwise fashion for rearward movement. Moreover, speed differentials between rollers 16′ and 16″ provide for rotational movement. In other words if roller 16′ rotates faster than roller 16″ when the rollers are actuated in a clockwise fashion, the mobile unit 12 will turn in the R direction. If the roller 16″ rotates faster than roller 16′ when the rollers are actuated in a clockwise fashion, the mobile unit 12 will turn in the L direction. If the roller 16′ rotates faster than roller 16″ when the rollers are actuated in a counter clockwise fashion, the mobile unit 12 will turn in the L direction. If the roller 16″ rotates faster than roller 16′ when the rollers are actuated in a counter clockwise fashion, the mobile unit 12 will turn in the R direction.

It will be readily understood that the mobile unit 12 can be provided in a variety of other configuration

The actuator 22 is operated by a user using a controller 24 in communication therewith. In this example, the controller 23 is a remote control unit.

A vehicle engaging element 19 is mounted to the chassis 20. In this example, the vehicle engaging element 19 comprises a platform 24 supporting a monitoring device 26. In this example, the monitoring device 26 comprises vehicle mounting elements in the form of magnets 28. The platform 24 includes a camera 29 in communication with the controller 23.

The monitoring device 26 comprises a window 25 providing the camera 29 with visual access therethrough

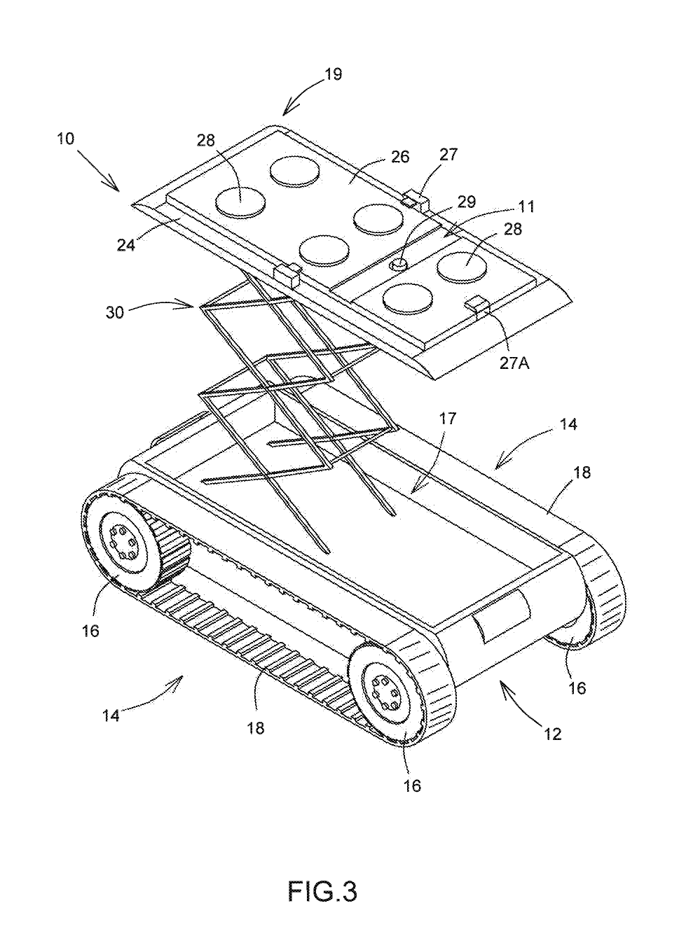

The platform 24 includes a pair of connectors 27 for holding the monitoring device 26 in place on the platform 24. The pair of connectors 27 are respectively oppositely disposed with each being positioned near a respective lateral side of the platform 24. The platform can also include a connector 27A (see FIG. 3) at a longitudinal end thereof for securing the front or rear ends of the monitoring device 26 to the platform. Each connector 27 includes a base structure 31 with an engaging element 33 extending therefrom for engaging the monitoring device 26. The engaging element 33 can comprises clamping, holding, locking elements and the like as is known in the art. The connectors 27 are in communication with the controller 23 to be selectively operated by the user for selectively securing the monitoring device 26 to the platform 24 or releasing the monitoring device 26 from the platform 24.

The monitoring device 26 can be a tracking device, such as a GPS unit, a listening device or a tracking and listening device. Of course, a variety of other suitable monitoring devices can also be used within the context of the disclosure.

In an embodiment, the monitoring device 26 comprises a support with magnets 28 and a groove 11 (see FIG. 3) for removably receiving therein a monitoring device which may include an opening for providing visual access to camera 29. The embodiments discussed herein can be interchangeably contemplated with element 26 as the monitoring device or as a support with a groove 11 or any other receiving element for receiving a monitoring device. In another embodiment, the magnets 28 comprise monitoring devices with a magnetic outer surface and element 26 comprises a support for theses magnetic monitoring devices. In another embodiment, the magnetic monitoring devices 28 are removably nested within the molded nests of the support 26.

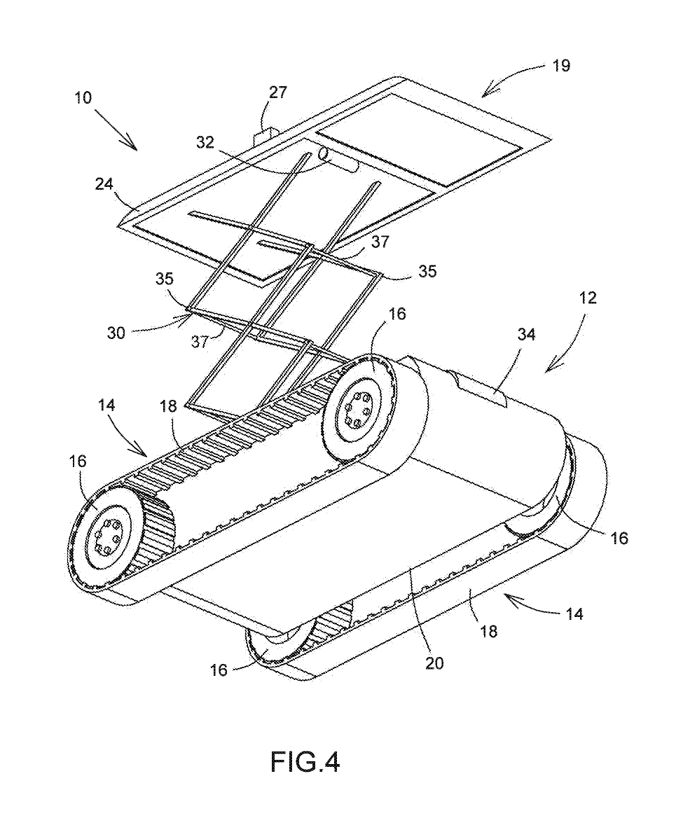

With reference to FIGS. 3, 4 and 5, a movement imparting element 30 is positioned between the platform 24 and the chassis 20 and connected thereto.

The movement imparting element 30 and the vehicle engaging element 19 are nested within a cavity 17 (see FIG. 3) formed in the chassis 20.

In this example the movement imparting element 30 is a scissor jack powered by an actuator 32 mounted on the underside of the platform 24. The actuator 32 is in provides the scissor jack 30 to reciprocally lift or descend the platform 24. In non-limiting examples, the movement imparting element 30 can be provided in the form of a variety of jack devices including without limitation jackscrews, house jacks and the like. The actuator 32 can thus power threaded screws mounted to the joints 35 of the scissor jack about axle 37. In another embodiment, actuators are mounted at the joints 35 of the scissor jack. Of course, the skilled artisan will appreciate that a variety of the movement imparting elements for moving the vehicle engaging element can be contemplated within the scope of the present disclosure.

The actuator 32 is in communication with the control unit 23 allowing the user to selectively lift and descend the platform 24.

It is understood herein that the actuators 22 and 32 as well as the movement imparting element 30 form part of a movement imparting assembly in communication with the controller 23 to both control the movement of the mobile unit 12 and the movement of the vehicle engaging element 24. As such, the movement imparting assembly can be provided in a variety of suitable configurations allowing with the controller 23 for remote control of the mobile unit 12 and remote control of the vehicle engaging element 24 within the context of the present disclosure.

In an embodiment, the mobile unit 12 includes a first camera 34 mounted at one of the front or rear ends of the chassis 22. In an embodiment, the mobile unit 12 includes a second camera 36 mounted at one of the front or rear ends of the chassis 22. In an embodiment, the mobile unit 12 includes one lateral camera 38 at one lateral side of the chassis 22. In an embodiment, the mobile unit 12 includes another lateral camera 38 mounted at the other lateral side of the chassis 22.

The cameras 34, 36, and 38 are in communication with the controller 23 which includes a display screen allowing the user to view the captured images.

Any one or all of the cameras 29, 34, 36 and 38 can be movable so as to provide a better range of vision to the remote user when controlling the mobile unit 12 via the controller 23.

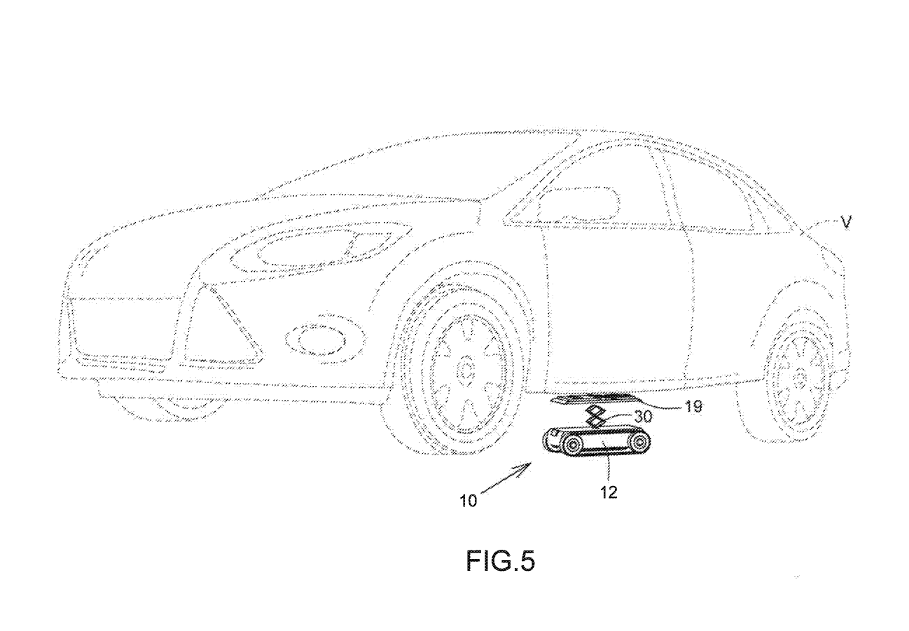

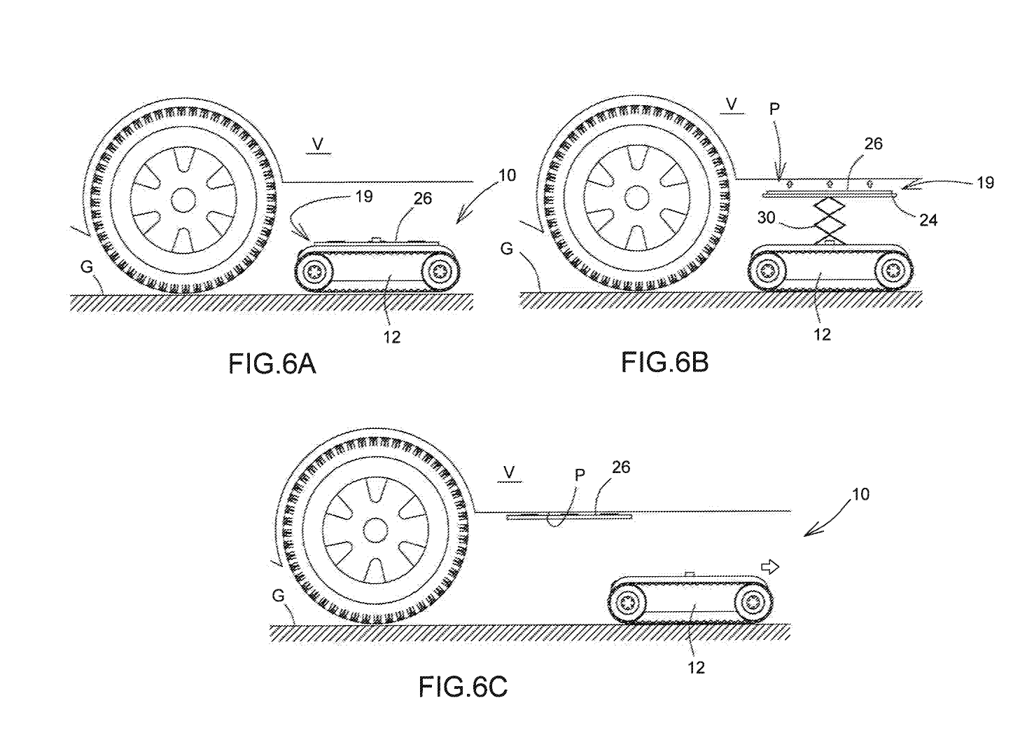

In operation and with the reference to FIGS. 5, and 6A-6C, the user is positioned at a substantial distance from the target vehicle V. The user will place the mobile unit 12 on ground G and remotely drive it towards and then beneath the target vehicle V as shown in FIG. 6A. The cameras 29, 34, 36 and/or 38 allow for the user to remotely drive the unit 12 without observing it. Once the mobile unit 12 is positioned beneath the target vehicle V as shown in FIG. 6A, the platform 24 is raised towards an underside metallic portion of the vehicle V as shown in FIGS. 5 and 6B.

Once the vehicle engagement element 19 has engaged a suitable underside portion P of the target vehicle V, as shown in FIG. 6B, it is mounted thereto via the magnets 28. The camera 29 allows the user to visualize via the control unit 23 the underside of the vehicle and select an appropriate portion P.

When the magnets 28 engage the desired underside portion of the vehicle the connectors 27 release the monitoring device 26 from the platform 24. The monitoring device 26 remains mounted to the target vehicle and the platform 24 is descended by the retracting scissor jack 24 towards the chassis 20. Once the platform 24 is fully retracted to its original position, the user remotely drives (as shown in FIG. 6C) the mobile unit 12 to their position for retrieval. When the monitoring operation is complete and the user wishes to retrieve the monitoring device 26, the user remotely drives the mobile unit 12 back to the same underside portion P of the target vehicle V, the camera 29 allows the user to visualize this underside portion P via the control unit 23, the user then lifts the platform 24, via the control unit 23, until it engages the monitoring device 26 currently mounted to this underside portion P. The connectors 27 are actuated to secure the monitoring device 26 to the platform 24. Once properly secured to the platform 24, the scissor jack 30 retracts and descends the platform 24 and the connected monitoring device 26 towards the chassis 20. Once disengagement from the target vehicle V is complete, the user remotely drives the mobile unit 12 with its monitoring device 26 to their position for retrieval.

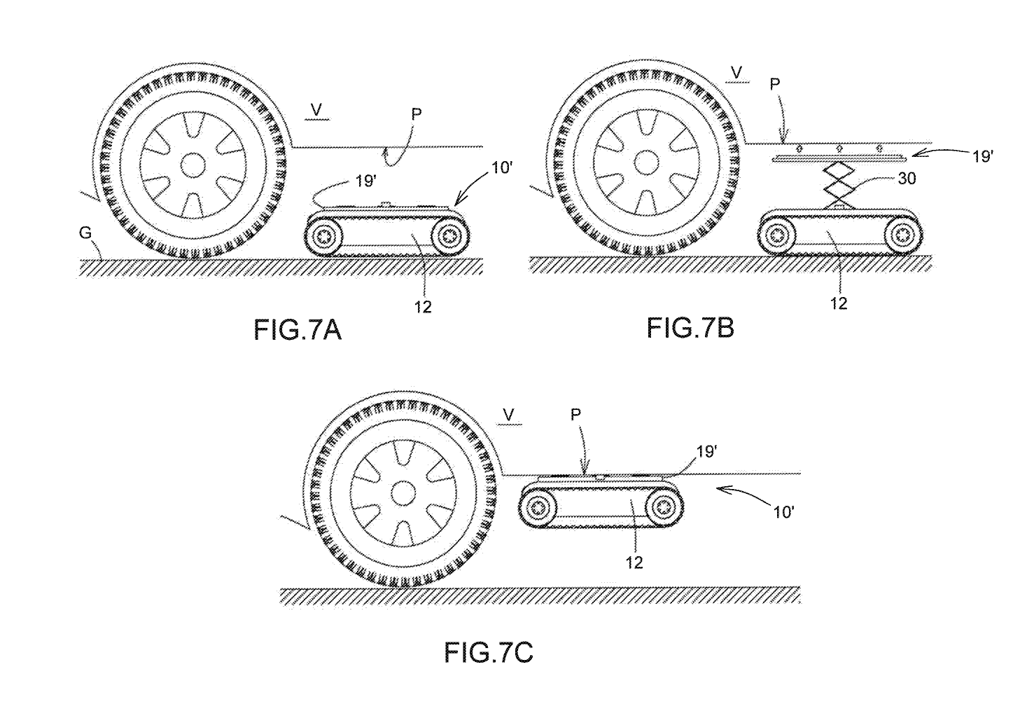

With reference to FIGS. 7A, 7B and 7C, there is shown a device 10′ that is similar to device 10 with the exception that the vehicle engagement element 19′ is a single integral member acting both as a platform and a monitoring device.

As previously explained, the user places the mobile unit 12 on ground G and remotely drive it towards and then beneath the target vehicle V as shown in FIG. 7A. Once the mobile unit 12 is positioned beneath the target vehicle V, vehicle engagement element 19′ is raised towards an underside metallic portion P of the vehicle V as shown in FIG. 6B. Once the magnets 28 have magnetically engaged a suitable underside portion P of the target vehicle V, the mobile unit 12 is lifted upwardly towards the vehicle engagement element 19′ secured to the vehicle V by the movement imparting element 30 as. Once the mobile unit 12 is secured to the target vehicle V (as shown in FIG. 6C), the monitoring device is activated for tracking and/or listening. When the user wishes to retrieve the mobile unit 12, the scissor jack 30 moves the chassis 20 downwardly away from the vehicle engagement element 19′ still secured to the target vehicle until the rollers 16 and endless track 18 engage the ground G. The vehicle engagement element 19′ is then disengaged from the target vehicle V by being moved downwardly by the retracting scissor jack 30 until it rests on the chassis 20. Once disengagement from the target vehicle V is complete, the user remotely drives the mobile unit 12 back to their position for retrieval.

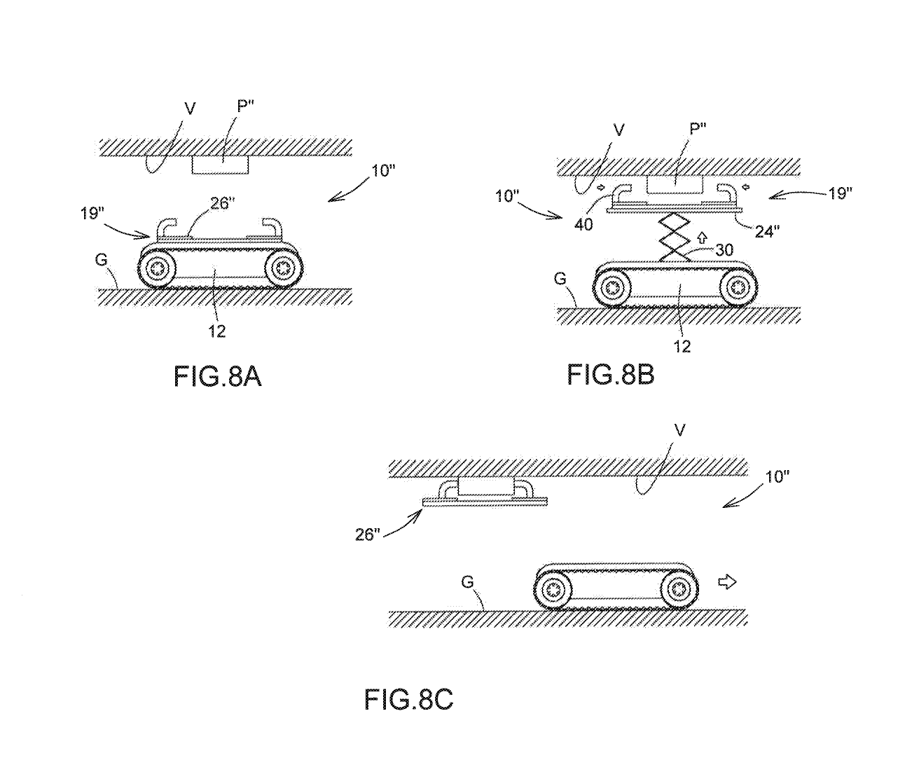

Turning now to FIG. 8A, 8B and 80 there is shown a device 10″ that is similar to device 10 with the exception that the mounting elements are not in the form of magnets but rather in the form of clamps 40 which extend from the monitoring device 26″.

FIG. 8A shows the mobile unit 12 being driven beneath the target vehicle V. Once the mobile unit 12 is beneath an appropriate portion P″ that the clamps 40 can clamp on to, the scissor jack 30 lifts the platform 24″ with the monitoring device 26″ to an appropriate position that provides for the clamps 40 to engage the portion P″ as shown in FIG. 8B. Once the clamps 40 clamp portion P″, the monitoring device 26″ is released and remains mounted to the vehicle with the mobile unit 12 being driven away for retrieval as shown in FIG. 8C. In another embodiment, the vehicle engaging element 19″ is a single piece comprising both the platform 24″ and the monitoring device 26″ in an integrated form.

The various features, configurations, characteristics, elements and advantages of the above described or illustrated embodiment can be combined in a variety of suitable ways within the scope of the appended claims to provide still other non-limiting embodiments. As such, it is to be understood that the disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been described hereinabove by way of embodiments thereof, it can be modified, without departing from the spirit, scope and nature of the subject disclosure as defined herein and/or defined in the appended claims.

What is claimed is:

1. A mobile monitoring device for monitoring a vehicle comprising:
a mobile unit;
a vehicle engaging element movably mounted to the mobile unit and comprising a monitoring device; and
a movement imparting assembly mounted to the mobile unit for imparting a movement to the mobile unit and to the vehicle engaging element,
wherein the controller provides for moving the mobile unit towards the vehicle and moving the vehicle engaging element onto the vehicle thereby providing for the monitoring device to be mounted to the vehicle.

2. A mobile monitoring device according to claim 1, further comprising controller in communication with the movement imparting assembly for control thereof.

3. A mobile monitoring device according to claim 1, wherein the monitoring device comprises mounting elements for being mounted to the vehicle.

4. A mobile monitoring device according to claim 3, wherein the mounting elements are selected from the group consisting of: magnets and clamps.

5. A mobile monitoring device according to claim 1, wherein the vehicle engaging element comprises a platform, the monitoring device being mounted to the platform.

6. A mobile monitoring device according to claim 1, wherein the vehicle engaging element and the monitoring device form a single integrated piece.

7. A mobile monitoring device according to claim 1, wherein the vehicle engaging element comprises connectors for connecting the monitoring device thereto.

8. A mobile monitoring device according to claim 7, wherein the connectors are movable between a connecting position and a releasing position, the controller providing for selectively releasing the monitoring device when mounted to the vehicle.

9. A mobile monitoring device according to claim 1, wherein the vehicle engaging element is moved onto the vehicle so as to be mounted thereto and wherein the movement imparting assembly provides for moving the mobile unit towards the vehicle engaging element mounted to the vehicle, thereby providing for mounting the mobile unit onto the vehicle.

10. A mobile monitoring device according to claim 9, wherein the movement imparting assembly provides for moving the mobile unit away from the vehicle subsequently to having been moved onto the vehicle.

11. A mobile monitoring device according to claim 1, wherein the mobile unit is configured to be moved by the movement imparting assembly beneath the vehicle, the vehicle engaging element being configured to be lifted by the movement imparting assembly so as to engage an underneath portion of the vehicle.

12. A mobile monitoring device according to claim 1, wherein the mobile unit comprises rollers in operative communication with the movement imparting assembly.

13. A mobile monitoring device according to claim 1, wherein the mobile unit comprises at least one camera in communication with the controller.

14. A mobile monitoring device according to claim 13, wherein the controller comprises a visual display for displaying the images captured by the camera.

15. A mobile monitoring device according to claim 1, wherein the controller provides for remotely controlling the movement imparting assembly.

16. A mobile monitoring device according to claim 1, wherein the controller is in communication with the monitoring device for receiving monitored information therefrom.

17. A mobile monitoring device according to claim 1, wherein the monitoring device comprises a tracking device.

18. A mobile monitoring device according to claim 17, wherein the tracking device is selected form the group consisting of a GPS unit, a listening device and any combination thereof.

19. A mobile monitoring device according to claim 1, wherein the vehicle engaging element comprises a camera.

20. A monitoring system comprising:
a plurality of the mobile monitoring devices of claim 1; and
a controller in communication with the monitoring device of each of the mobile monitoring devices for receiving monitoring information therefrom.
